(19) United States
(12) Patent Application Publication
(10) Pub. No.: US 2012/0140640 A1
(43) Pub. Date: Jun. 7, 2012

(54) APPARATUS AND METHOD FOR DYNAMICALLY PROCESSING PACKETS HAVING VARIOUS CHARACTERISTICS

(75) Inventors: Wang-Bong LEE, Daejeon-si (KR); Sang-Wan Kim, Daejeon-si (KR); Sang-Kil Park, Daejeon-si (KR)

(73) Assignee: ELECTRONICS AND TELECOMMUNICATIONS RESEARCH INSTITUTE, Daejeon-si (KR)

(21) Appl. No.: 13/311,968

(22) Filed: Dec. 6, 2011

(30) Foreign Application Priority Data
Dec. 6, 2010 (KR) 10-2010-0123319

(51) Int. Cl. H04L 12/26; H04L 12/56

(52) U.S. Cl. 370/242; 370/401; 370/389

(57) ABSTRACT

An apparatus for processing different types of packets using various interfaces and method thereof. The apparatus uses a general-purpose processor, instead of a particular network processor, and uses a general open source software compiler without the use of a particular compiler and an application program interface (API) for use in processing a specific packet, and accordingly, it is easy to reuse software when upgrading hardware and software.

### CROSS-REFERENCE TO RELATED APPLICATION(S)

This application claims the benefit under 35 U.S.C. §119(a) of Korean Patent Application No. 10-2010-0123319, filed on Dec. 6, 2010, in the Korean Intellectual Property Office, the entire disclosure of which is incorporated herein by reference for all purposes.

### BACKGROUND

1. Field

The following description relates to a technology for processing various types of packet incoming from an interface, and more particularly, to an apparatus and method for processing various packets by simultaneously executing packet processing modules that process various packets or by dynamically upgrading the packet processing modules.

2. Description of the Related Art

A general packet processing apparatus may be categorized into a low-speed type, a high-speed type, and any other types according to interfaces.

A low-speed type packet processing apparatus may be a small-sized wired/wireless home router used at home and office, and a high-speed type packet processing apparatus may be a switch or a router for processing edge/core packet for network connection in a data center and ISP.

A high-speed type packet processing apparatus may provide various forms of interfaces such as an Ethernet interface, a packet of sonnet (PoS) interface, and the like. In particular, the high-speed type packet processing apparatus may use a network processor for high-speed packet processing.

However, the use of a network processor may cause difficulties in development and upgrade of the device. First, a specific API and a compiler which are provided by a relevant vendor should be used, which results in significant cost for the development. Second, if a specific vendor does not support a pertinent version of a network processor while releasing a new version of a network processor, it is difficult to reuse corresponding software. Hence, there is an increasing need for a technology which allows the use of general open source software (OSS) compiler instead of a particular packet processing API and a specific compiler by use of a general-purpose processor instead of a specific network processor.

Furthermore, it is required to develop a technology which allows reuse of software even after upgrade of hardware and software and which is applicable to a network device that forwards packets, a deep packet inspection (DPI) device that analyzes a packet in real time, a network device that requires dynamic programming loading, and a firewall device that analyzes a packet for blocking is required in case of upgrade of hardware and software.

### SUMMARY

The following description relates to a packet processing apparatus having various interfaces and a method thereof.

In one general aspect, there is provided a packet processing apparatus interposed between networks for processing packets having various characteristics, the packet processing apparatus including: an interface card configured to perform a packet processing service according to a protocol defined by a user; and a control server card configured to set the interface card according to the protocol and control the interface card to perform the packet processing service according to the set protocol.

The packet processing module may include an interface card configured to perform a packet processing service according to a protocol defined by the user and a control server card configured to set the interface card according to the protocol and control the interface card to perform the packet processing service according to the set protocol.

The packet processing module may be configured to comprise one or more interface cards to execute packet processing services for processing packets having different characteristics between the networks.

The packet processing module may be further configured to further comprise a communication channel over which a communication is made between the interface cards and between the control server card and the interface card.

The interface card may be configured to comprise one or more interfaces to perform communication for network communication according to the protocol defined by the user.

The interface card may be further configured to comprise a packet processing unit configured to execute the packet processing service, a memory block configured to store incoming and outgoing packets, an interface configured to be connected with a general-purpose interface device on the network and communicate with the packet processing unit and the memory block, and an auxiliary memory unit configured to store an operating system of the packet processing unit and information on the protocol defined by the user.

The packet processing unit may be a general central processing unit (CPU) or a multi-core CPU.

The packet processing module may be further configured to comprise one or more interface cards to execute packet processing services for processing packets having different characteristics between the networks, and each of the interface cards may be configured to comprise an internal interface configured to perform a communication between the interface cards and between the control server card and the interface card.

The internal interface may be a peripheral component interconnect express (PCI-E), a peripheral component interconnect extended (PCI-X), or 10 G or 100 G Ethernet bus.

The packet processing unit may be configured to, under the control of the control server card, dynamically add or delete an application program to execute a packet processing service requested by a user who wishes to perform packet processing between networks.

The control server card may be further configured to comprise a control unit configured to manage a scheduler to execute a packet processing service between the interface cards, an interface management unit configured to control operation of the interface cards, a program control unit configured to load or unload an application program to or from the interface card to execute the packet processing service according to the protocol defined by the user, and a storage unit configured to store an operating system of the control unit and information on the application program.

In another general aspect, there is provided a method for dynamically processing one or more packets having various characteristics between networks, the method including: receiving a packet from the network; recognizing a characteristic of the received packet by analyzing a header of the packet; executing a packet processing service according to the recognized characteristic of the packet; and when the recognized characteristic of the packet is not suitable to the packet processing service, discarding the packet.

The recognizing of the characteristic of the packet may include analyzing the header of the received packet and searching for a packet processing service suitable to the packet based on the analysis result.

The recognizing of the characteristic of the packet may include when the header of the received packet indicates a packet processing service that is requested by a user, searching for the corresponding packet processing service.

The executing of the packet processing service may include executing the found packet processing service suitable to the received packet.

The discarding of the packet may include, when a packet processing service suitable to the received packet is not found, notifying of a failure in processing packet and discarding the packet.

Other features and aspects may be apparent from the following detailed description, the drawings, and the claims.

### BRIEF DESCRIPTION OF THE DRAWINGS

FIG. 1 is a diagram illustrating an example of a packet processing apparatus deployed between networks.

FIG. 2 illustrates an example of the packet processing module shown in the example illustrated in FIG. 1.

FIG. 3 is a diagram illustrating an example of an interface card of a packet processing apparatus.

FIG. 4 is a diagram illustrating an example of a control server card of a packet processing apparatus.

FIG. 5 is a flowchart illustrating an example of a packet processing method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

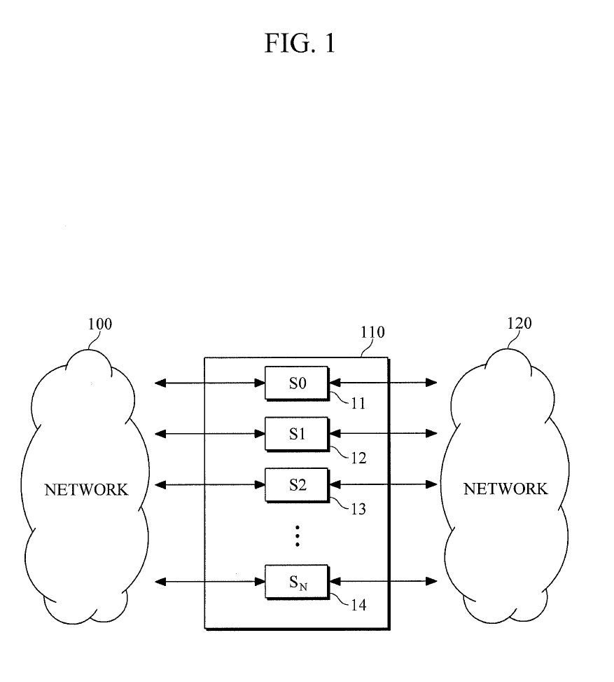

FIG. 1 is a diagram illustrating an example of a packet processing apparatus deployed between networks. Referring to FIG. 1, the packet processing apparatus 110 may be interposed between the networks 100 and 120, and may include a plurality of packet processing modules 11, 12, 13, and 14 to process packets. Each of packet processing modules 11, 12, 13, and 14 corresponds to each application program that performs a packet processing service or a logical or virtual module that executes the application program, which will be described later. Each packet processing module 11, 12, 13, and 14 may be referred to as a packet processing module service.

The packet processing module 11, 12, 13, and 14 of the packet processing apparatus 110 may process a packet, which is forwarded from a network, according to a characteristic of the packet, and there may be one or more packet processing modules to process multiple packets. The characteristic of a packet may be defined based on various information specified in a header of a packet, such as a packet type, and data content specified in a payload of the packet. For example, recent Internet packets have a format complying with a standard packet type. The packet processing apparatus 110 shown in the example illustrated in FIG. 1 is configured to be capable of processing not only packets of a standard type having a standard header but also packets according to a packet header and packet content that complies with a type defined by a user and a packet behavioral pattern which is defined by a user.

Each of the packet processing modules 11, 12, 13, and 14 may be dedicated to process a specific packet of a particular characteristic, and may be changed to process a different packet according to a packet status.

The network 100 may be a network connectable to the packet processing apparatus 110, and may be a general Internet.

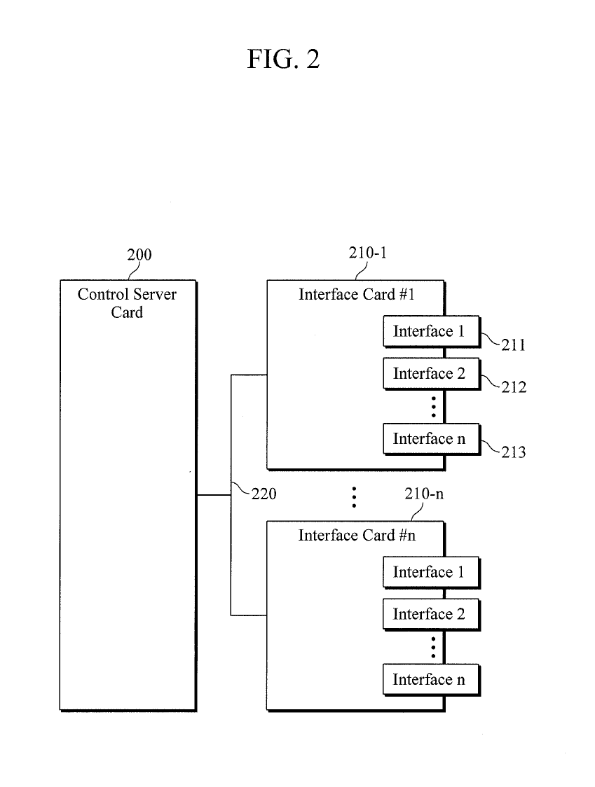

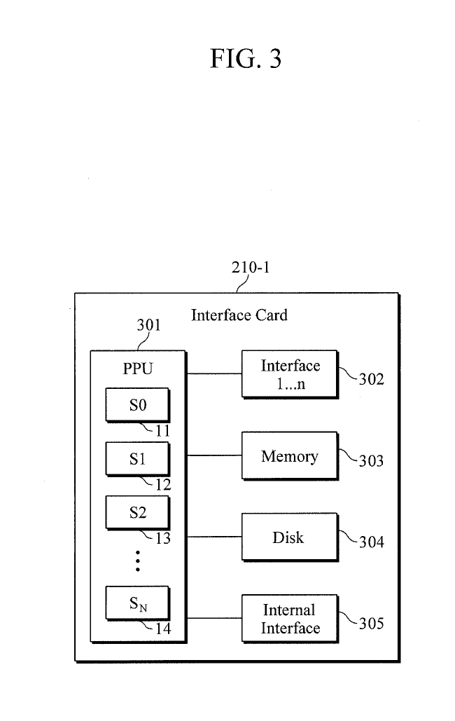

In the example shown in FIG. 1, the packet processing apparatus includes n modules 11, 12, 13, and 14 which provide n services. These modules may dynamically load or unload services that a user requires while a system is running. The packet processing modules 11, 12, 13, and 14 may process corresponding packets. The packet processing modules 11, 12, 13, and 14 may be added, removed and/or executed by a management module (an interface management unit 402 or a program control unit 403) inside a control server card 200 illustrated in FIG. 2 or by an externally connected management module (not shown). In addition, the packet processing modules 11, 12, 13, and 14 may be connected to one or multiple interfaces of an interface card 210-1 to transmit and receive packets. Each of the packet processing modules 11, 12, 13, and 14 may be loaded to the interface card 210-1 using interface mapping information and then executed. Each of the packet processing modules 11, 12, 13, and 14 loaded to the interface card 210-1 may process the packets using hardware resources such as interfaces 302, memory 303, a disk 304, and an internal interface 305 as shown in FIG. 3. The interface mapping information is information to indicate which interface a service module for use in processing a packet is to use. The interface mapping information may be provided in the form of a table. The interface mapping information may be stored beforehand in a predefined storage space (for example, inside of a packet processing unit (PPU) 301 shown in FIG. 3) of the packet processing apparatus 110.

FIG. 2 illustrates an example of the packet processing apparatus. Referring to FIG. 2, packet processing apparatus 110 may include a control server card 200, at least one interface card 210-1 to 210-n, and a communication channel 220. The example will be described, focusing on the interface card 210-1.

The interface card 210-1 may provide a packet processing service according to protocols defined by the user. In addition, the interface card 210-1 may include one or more interface units 211, 212, and 213 which communicate with one another according to the protocols defined by the user for network communication.

The control server card 200 may set the interface card 210-1 in accordance with the protocols, and may control the interface card 210-1 to perform packet processing according to the defined protocols.

The communication channel 220 may enable communication between interface cards 210-1 to 210-n and communication between the control server card 200 and the interface card 210-1.

The control server card 200 may control the interface card 210-1 for processing packets. The control server card 200 may primarily perform interface card booting control, program loading control, routing control, monitoring, user control, resource control, and the like.

The interface card 210-1 may process packets. Primary functions of the interface card 210-1 may include packet parsing, packet processing based on the function of the packet, resource control, and the like.

The packet parsing and processing may be defined according to the protocol specified by the user. For example, the packet parsing and processing may be defined as generating a flow using a specific field of an IPv4 packet or performing packet drop when a particular field of an IPv6 packet is included. This definition may be made according to a particular purpose of a user.

The resource control may allocate resources (CPU, memory, and the like) of the interface card 210-1 to the packet processing of the user and control the allocated resources. The interface card 210-1 may include a variety of network interfaces 211, 212, and 213. For example, Ethernet 1 G/10 G/100 G interfaces may be used.

The communication channel 220 may be a channel through which a signal is transmitted between interfaces, and between the control server card 200 and the interfaces 210-1 to 210-n. PCI bus, Ethernet 10 G or 100 G switching channel may be used. Alternatively, a native communication channel constituting the system may be used.

If the module 111 uses Advanced Telecommunications Computing Architecture (ATCA) standards, a relevant communication channel may be used. Alternatively, a non-blocking crossbar switching channel may be used.

FIG. 3 is a diagram illustrating an example of an interface card of a packet processing apparatus. Referring to FIG. 3, interface card 210-1 may include a packet processing unit (PPU) 301, an interface 302, a memory block 303, an auxiliary memory unit (e.g. disk) 304, and an internal interface 305.

The PPU 301 performs a packet processing service. The memory block 303 stores incoming and outgoing packets.

The interface 302 is connected to a general-purpose interface device on a network and communicates with the packet processing unit 301 and the memory block 303.

The auxiliary memory unit 304 may store an operating system of the packet processing unit 301 and information on protocol set by a user.

The internal interface 305 may perform communications between the interface card 210-1 and another interface card 210-n, and between a control server card 200 (Refer to FIG. 2) and the interface card 210-1.

The PPU 301 is a central processing unit that processes packets. A single core processor or a multi-core processor is used as the PPU 301.

The multi-core processing unit is an integrated circuit consisting of two or more processors to process a number of tasks more efficiently while improving a performance and reducing power consumption.

At present, 64-multi-core integration is possible. The single core processing integration has inherent limitation on performance improvement due to heat dissipation and integration.

Thus, it is anticipated that a technology for improving multi-core processing performance will be developed continuously. The present invention provides a multi-core processor in which a packet processing module dynamically forms a function on the basis of a core and performs the function, or in which a packet processing module is configured dynamically using a single core.

Packet processing modules 11, 12, 13, and 14 of the PPU 301 are under the control of the control server card 200. The packet processing modules 11, 12, 13, and 14 may be implemented in various ways according to the functionality, and loaded to be operated on the interface card 210-1 for a corresponding purpose. That is, under the control of the control server card 200, the PPU 301 may dynamically add or delete an application program to execute a packet processing service requested by a user who wishes to perform packet processing between networks.

For example, to operate as an interface card for an IPv4 packet forwarding processing function, IPv4 packet parser, routing lookup, packet reassembly, and packet header correction function are performed. The PPU 301 performs functions to load/unload each of the packet processing modules 11, 12, 13, and 14, a resource control function, and a scheduling function.

The PPU 301 may be equipped with Linux or BSD, which is open source software, as a primary operating system. In the example, a particular network processor is not used for packet processing. Instead, a general-purpose processor is used, and thus there is no need for using a particular complier and an API for use in processing a particular packet.

For example, generally used open source software may be used instead of a particular compiler. To this end, the PPU 301 may use a general purpose CPU or a multi-core-CPU, and a general-purpose operating system is used instead of a specific OS.

The interface 302 is connected to a general-purpose interface device, the PPU 301, and the memory block 303. The interface 302 may include an Ethernet 1 G/10 G/100 G interface or a POS interface.

In addition, the interface 302 may include a serial interface for management. Also, the interface 302 may be connected to an interface for management and for video graphics array (VGA) for use in development.

The memory block 303 stores incoming and outgoing packets. For a fast packet analysis, a ternary content-addressable memory (TCAM) technique is utilized. A type of memory in use may vary according to the type of the PPU 301.

The auxiliary memory unit 304 is a device to process the operating system and information of the PPU 301. Other additional devices, such as flash memory, may be mounted, if necessary. In addition to the aforementioned devices, elements, for example, a power module, which is required to operate the interface card in the example, may be further provided, but such elements are less relevant, and thus the detailed descriptions thereof will be omitted.

The internal interface 305 may be an interface being internally connected with a system. Communications are carried out between the interface cards 210-1 to 210-n, and between the control server card 200 and the interface card 210-1 via the internal interface 305 as a channel. For implementation of a high-speed interface, peripheral component interconnect express (PCI-E), peripheral component interconnect extended (PCI-X), 10 G Ethernet bus, 100 G Ethernet bus, etc. are used. The application of the internal interface 305 may vary according to the purpose of the system to be equipped with the internal interface.

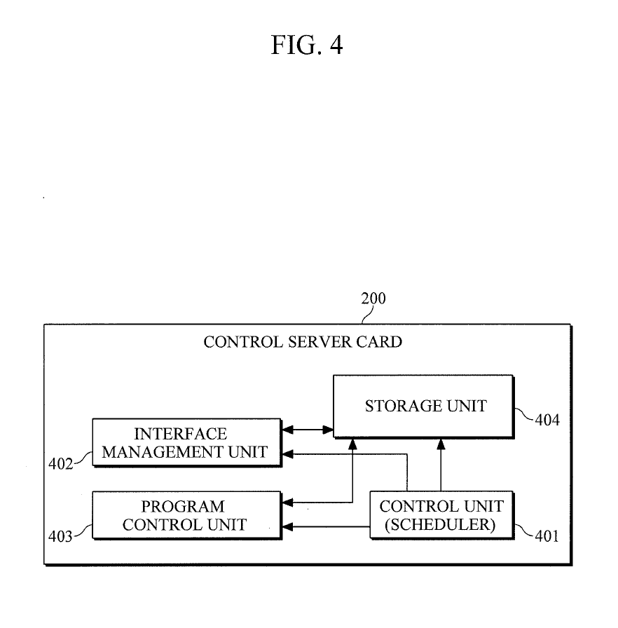

FIG. 4 is a diagram illustrating an example of a control server card of a packet processing apparatus. Referring to FIG. 4, control server card 200 may include a control unit 401, an interface management unit 402, a program control unit 403, and a storage unit 404.

The control unit 401 may manage a scheduler for a packet processing service between the interface cards 210-1 to 210-n.

The interface management unit 402 may control the operation of each of the interface cards 210-1 to 210-n.

The program control unit 403 may load or unload an application program for use in a packet processing service to or from a predetermined interface card (for example, the interface card 210-1) according to protocol defined by a user.

The storage unit 404 may store an operating system of the control unit 401 and information on the operating system. The control unit 401 performs a resource control function and a scheduling function. The interface management unit 403 manages various application programs. The control server card 200 may be equipped with Liux or BSD, which is open source software. Moreover, the control server card 200 may be equipped with Windows® to manage one or more application programs.

The present invention is not characterized in the operating systems as described hereinabove, but in the connection of interface devices capable of processing various packets and the configuration of software modules.

The storage unit 404 is a memory and disk device to store application programs and data of the control unit 401.

The interface management unit 402 may manage and control the interface cards 210-1 to 210-n connected with the system. The interface management unit 402 performs interface booting, OS loading, and the like. The program control unit 403 may load/upload various packet processing modules 11, 12, 13, and 14 to/from the interface cards 210-1 to 210-n.

Each of the packet processing modules 11, 12, 13, and 14 is an application program to be created for processing a specific packet. For example, there may be a module to create forwarding information.

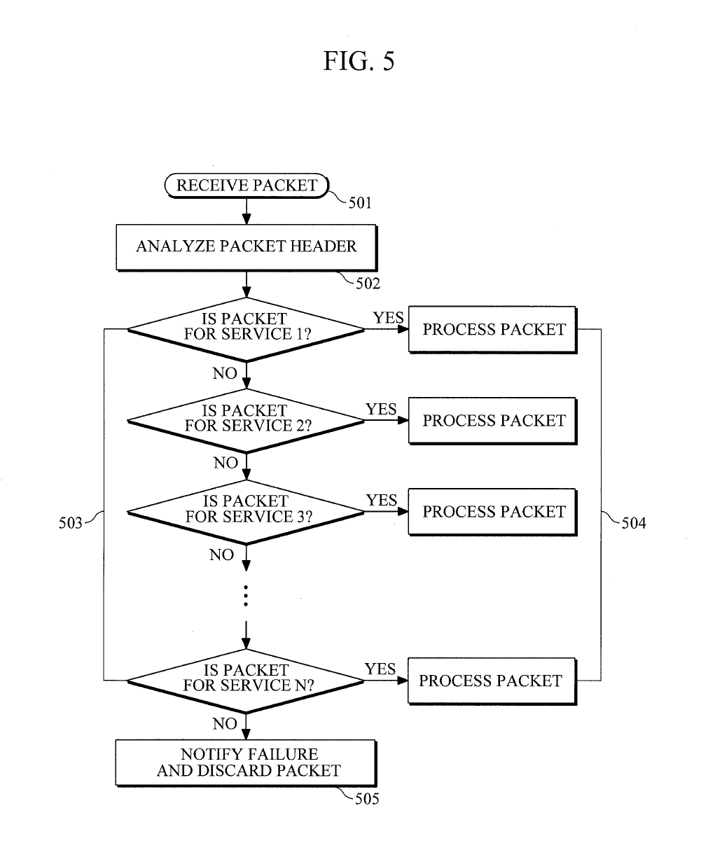

FIG. 5 is a flowchart illustrating an example of a packet processing method.

The flow begins with receiving a packet from a network in 501.

In 502, a header of the received packet is analyzed to recognize a characteristic of the packet. A packet processing service is performed according to the recognized packet characteristic in 503 and 504.

If the recognized characteristic of the packet is not suitable to a packet processing service, it is notified that the packet cannot be processed and the corresponding packet is discarded in 505.

In short, the packet is received through an interface in 501, and a header of the received packet is analyzed in 502. It is determined to which service the packet corresponds in 503, and the packet is transmitted to a module corresponding to the determined service in 504.

In the case of a packet that cannot be processed, a failure notification is issued and then the packet is discarded in 505. The type of service of the packet may be determined according to various policies.

For example, a particular IP address of IPv4 may be mapped to a service. Alternatively, a particular IP address of IPv6 may be mapped to a service. Various rules may be combined to be used.

The user may use a specific packet header set by the user. The specific packet header may be mapped to a particular service. Various packet formats may be available.

The following embodiments may be used to apply the packet processing apparatus as shown in the example illustrated in FIG. 1 by use of the packet processing method as illustrated in FIG. 5.

### Embodiment 1

The packet processing apparatus and method as set forth in the above examples may be applied for real-time software upgrade. A packet processing module for a particular purpose may be implemented, and the packet processing module may be dynamically loaded to a network.

An example assumes that an interface card processes an incoming user packet with an existing service S0. A module service S1 for processing a specific packet is loaded to an interface card, thereby substituting for the existing service.

### Embodiment 2

An IP packet forwarding processing module is implemented to be applied to a general router. An IP packet parsing function, a routing lookup function, a packet correction function, and a packet forwarding function are loaded to a PPU.

A routing protocol function is implemented in a control server to create forwarding information. The created forwarding information is downloaded for use in forwarding look-up. In addition, an interface card may include a plurality of IP packet forwarding processing modules. The IP packet forwarding processing modules are, respectively, executed by cores to process packets.

### Embodiment 3

It may be possible to apply the packet processing apparatus and method as described in the above examples to a network apparatus for forwarding packets, a deep packet inspection (DPI) apparatus for analyzing a packet in real time, a network apparatus requiring dynamic program loading, and a firewall apparatus for analyzing and blocking packets.

### Embodiment 4

It may be possible to apply the packet processing apparatus and method as described in the above examples to a network apparatus that processes an experimental packet for the educational purpose or for the purpose of a trial service.

As illustrated in the above examples, it is possible to reduce development costs and time, as compared to a method of developing a general packet processing apparatus. In particular, in upgrading hardware and software, the software can be reused. When hardware is replaced, software cannot be compatible with the replaced hardware since hardware has unique compiler.

In addition, it is possible to reuse a code since the packet processing apparatus does not use an inherent API of a particular network processor, but instead use generally utilized open source software.

Moreover, it is possible to concurrently execute a plurality of packet processing modules that process various packets, or to dynamically upgrade the packet processing modules. Accordingly, multi-function packet processing can be implemented. The application of the packet processing apparatus according to the present invention may implement a service-aware packet processing system, thereby being able to support various services without appreciable cost.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A packet processing apparatus interposed between networks for processing packets having various characteristics, the packet processing apparatus comprising:
an interface card configured to perform a packet processing service according to a protocol defined by a user; and
a control server card configured to set the interface card according to the protocol and control the interface card to perform the packet processing service according to the set protocol.

2. The packet processing apparatus of claim 1, further comprising:
one or more interface cards to execute packet processing services for processing packets having different characteristics between the networks.

3. The packet processing apparatus of claim 2, further comprising comprise a communication channel over which a communication is made between the interface cards and between the control server card and the interface card.

4. The packet processing apparatus of claim 1, wherein the interface card is configured to comprise one or more interfaces to perform communication for network communication according to the protocol defined by the user.

5. The packet processing apparatus of claim 4, wherein the interface card is further configured to comprise
a packet processing unit configured to execute the packet processing service,
a memory block configured to store incoming and outgoing packets,
an interface configured to be connected with a general-purpose interface device on the network and communicate with the packet processing unit and the memory block, and
an auxiliary memory unit configured to store an operating system of the packet processing unit and information on the protocol defined by the user.

6. The packet processing apparatus of claim 5, wherein the packet processing unit is a general central processing unit (CPU) or a multi-core CPU.

7. The packet processing apparatus of claim 5, wherein each of the interface cards is configured to comprise an internal interface configured to perform a communication between the interface cards and between the control server card and the interface card.

8. The packet processing apparatus of claim 7, wherein the internal interface is a peripheral component interconnect express (PCI-E), a peripheral component interconnect extended (PCI-X), or 10 G or 100 G Ethernet bus.

9. The packet processing apparatus of claim 1, wherein the packet processing unit is configured to, under the control of the control server card, dynamically add or delete an application program to execute a packet processing service requested by a user who wishes to perform packet processing between networks.

10. The packet processing apparatus of claim 2, wherein the control server card is further configured to comprise
a control unit configured to manage a scheduler to execute a packet processing service between the interface cards,
an interface management unit configured to control operation of the interface cards,
a program control unit configured to load or unload an application program to or from the interface card to execute the packet processing service according to the protocol defined by the user, and
a storage unit configured to store an operating system of the control unit and information on the application program.

11. A method for dynamically processing one or more packets having various characteristics between networks, the method comprising:
receiving a packet from the network;
recognizing a characteristic of the received packet by analyzing a header of the packet;
executing a packet processing service according to the recognized characteristic of the packet; and
when the recognized characteristic of the packet is not suitable to the packet processing service, discarding the packet.

12. The method of claim 11, wherein the recognizing of the characteristic of the packet comprises analyzing the header of the received packet and searching for a packet processing service suitable to the packet based on the analysis result.

13. The method of claim 11, wherein the recognizing of the characteristic of the packet comprises, when the header of the received packet indicates a packet processing service that is requested by a user, searching for the corresponding packet processing service.

14. The method of claim 12, wherein the executing of the packet processing service comprises executing the found packet processing service suitable to the received packet.

15. The method of claim 14, wherein the discarding of the packet comprises, when a packet processing service suitable to the received packet is not found, notifying of a failure in processing packet and discarding the packet.
